(19) United States
(12) Patent Application Publication
(10) Pub. No.: US 2026/0042226 A1
(43) Pub. Date: Feb. 12, 2026

(54) END EFFECTOR AND ROBOT HAVING AN END EFFECTOR

(71) Applicant: CENTROTHERM INTERNATIONAL AG, Blaubeuren (DE)

(72) Inventors: Patrick PELZ, Blaubeuren (DE); Ralf REIZE, Blaubeuren (DE); Patrick SCHMID, Blaubeuren (DE)

(21) Appl. No.: 19/102,107

(22) PCT Filed: Aug. 11, 2023
(86) PCT No.: PCT/EP2023/072266

§ 371 Date: Feb. 7, 2025

(30) Foreign Application Priority Data
Aug. 11, 2022 (DE) 10 2022 002 932.4

(51) Int. Cl. B25J 11/00; B25J 15/00

(52) U.S. Cl. CPC B25J 11/0095; B25J 15/0014; B25J 15/0057

(57) ABSTRACT

An end effector is described which is suitable for handling both wafers and wafer cassettes. The end effector has a first gripping unit configured to pick up and hold individual wafers and a second gripping unit configured to pick up and hold a wafer cassette, wherein the first and second gripping units are connected to each other in such a way that they can be attached to a common robot arm and that they are arranged at an angle to each other so that they do not interfere with each other during operation.

### TECHNICAL FIELD

The present invention relates to an end effector and a robot having an end effector for use in the semiconductor or PV industry.

### BACKGROUND

In the semiconductor or PV industry, it is common practice to expose wafers to various processes in clean rooms or ultra-clean rooms (hereinafter referred to as cleanrooms). These processes can include individual processes as well as batch processes. They can be carried out in direct succession or with a time delay. Between the processes with a time delay the wafers are usually stored in so-called wafer cassettes (also known as wafer carriers), wherein different types and sizes of wafer cassettes are used. The wafers and wafer cassettes are usually handled by robots, wherein designated robots are provided for the wafers and for the wafer cassettes, each of which has its own footprint (floor space requirement), although this is usually limited.

Wafer robots have an end effector for picking up and holding one or more wafers for transporting them, for example between a wafer cassette and a process station and vice versa (possibly into another wafer cassette). The wafer robot may, however, also transport picked-up wafers directly between process stations. When transporting wafers from/to wafer cassettes, these are usually in a designated loading and/or unloading position. The fact that the wafers are essentially always transported from/to the same position simplifies the control of the wafer robot. The wafer cassettes are transported via the designated cassette robot, for example from an airlock to the loading and/or unloading position. To transport different types and/or sizes of wafer cassettes, the end effector may need to be changed. In addition, the work paths of the two robots (wafer robot and cassette robot) in part cross each other, so that they must be coordinated accordingly to avoid collisions. Furthermore, each robot must be individually taught to the environment and the respective transport positions. Cassette handling is of particular interest in an environment with an internal stocker for the cassettes.

### SUMMARY

It is an object of the present invention to eliminate at least one of the above disadvantages or at least provide an improvement. According to the invention, this object is solved by an end effector according to claim 1 and a robot according to claim 8.

In particular, an end effector is provided which comprises a first gripping unit configured to pick up and hold individual wafers and a second gripping unit configured to pick up and hold a wafer cassette. The first and second gripping units are connected to each other in such a way that they can be attached to a common robot arm and are arranged at an angle to each other so that they do not interfere with each other during operation. Such an end effector makes it possible to transport both wafers and wafer cassettes via a single robot without having to change the end effector. This may reduce the footprint and hardware for handling and the associated costs. Potential sources of particles and errors are reduced as there are fewer moving parts, which is particularly advantageous for clean room applications. This can also simplify the teaching of a robot, as they have a common origin and certain approach positions (wafer cassette/wafer pick-up/deposit) at least partially match.

In one embodiment, the first and second gripping units are arranged at an angle of approximately 180°to each other, wherein it is assumed here that the gripping units each for example have a central axis and that these are offset by 180°to each other.

Preferably, the first and second gripping units are connected to one another via a coupling unit, wherein the coupling unit can be connected to the common robot arm in such a way that the coupling unit connects at least one connection terminal for a working medium, preferably the same connection terminal, with the first and second gripping units for the actuation of the respective gripping units. The robot arm may, for example, have a connection terminal for compressed air, vacuum and/or electricity in order to be able to drive the gripping units. Preferably, the same connection may be used to control both the first and the second gripping unit, wherein it may be possible to switch between operating the first or the second gripping unit. The end effector may have a rotary unit by means of which the end effector can be rotated between at least two positions, preferably back and forth, on the robot arm, wherein the position of the end effector determines the readiness for use of the first or second gripping unit. Such a rotation could, for example, also result in a corresponding connection of the working medium being available only to the ready-to-use gripping unit. A back and forth rotation can simplify the assembly, as it is possible to work with end stops. Alternatively, the end effector can also be rigidly attached to the robot arm and the respective gripping unit can only be positioned via the movement of the robot arm.

The first gripping unit is preferably formed as a vacuum gripper, a Bernoulli gripper or an edge gripper. The first gripping unit can be formed as a single gripper for picking up a single wafer or as a multi-gripper for picking up several wafers.

In one embodiment, the second gripping unit has movable jaws, wherein the contour of the jaws is preferably formed in such a way that they can accommodate at least two different cassette sizes or types with the same amount of movement. This makes it possible to avoid changing the end effector for handling different types/sizes of wafer cassettes. Furthermore, the same movement can be set when teaching the end effector so that handling is possible even without knowledge of the cassette type or size. For this purpose, the contour can, for example, have offset contact or gripping surfaces and/or support surfaces in the direction of movement (for opening/closing) of the jaws, which cooperate with the wafer cassettes. In particular, the jaws can each have two support surfaces located at different levels, which are also offset from each other in the direction of movement of the jaws.

The movable jaws can, for example, be adjustable via a cylinder unit that can be operated with compressed air and/or negative pressure, wherein the jaws can for example be mechanically biased into a gripping position to prevent the jaws from opening unintentionally if the working medium fails.

Robot comprising a drive train with at least one robot arm which carries an end effector according to one of the preceding claims at its distal end.

### BRIEF DESCRIPTION OF THE DRAWINGS

The invention is explained in more detail below with reference to the drawings, in the drawings:

FIG. 1 is a schematic top view of an exemplary wafer processing system with a robot having an end effector according to the invention;

FIG. 2 is a schematic, perspective view of a robot with an end effector according to the invention;

FIG. 3 is a perspective view of an end effector according to the invention;

FIG. 4 is a perspective top view of an end effector according to the invention;

FIG. 5 is a perspective view of a gripping jaw when gripping a wafer cassette of a first type;

FIG. 6 is a perspective view of the gripping jaw according to FIG. 5 when gripping a wafer cassette of a second type;

FIGS. 7 and 8 are perspective views of an alternative end effector in respective different operating positions.

### DESCRIPTION

The relative terms used in the following description, such as left, right, above and below, refer to the drawings and are not intended to limit the application in any way, even though they may indicate preferred arrangements. The term substantially is intended to cover customary deviations in the range of not more than 5%, with reference to angular ranges, deviations of up to 2°are intended to be covered.

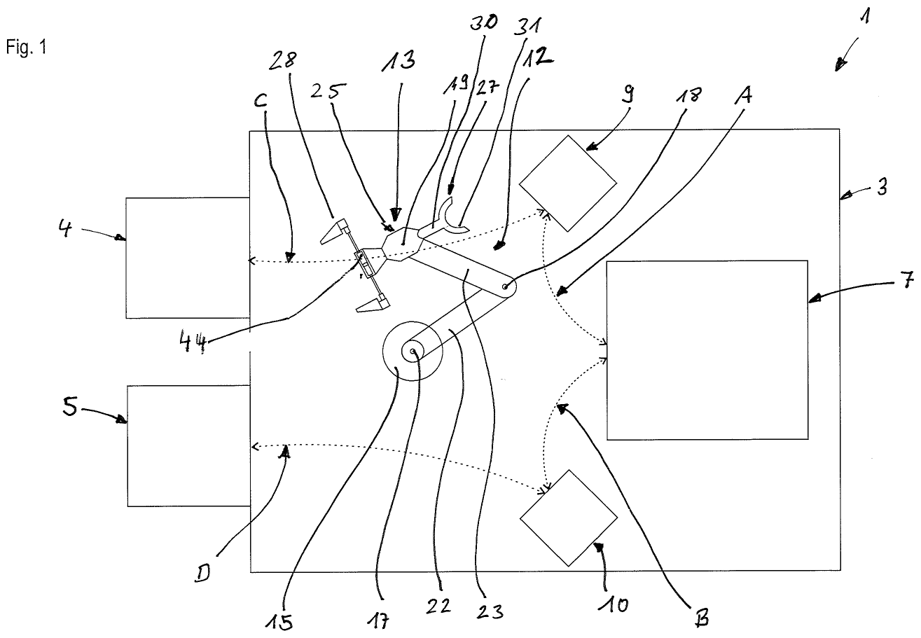

FIG. 1 shows a schematic top view of an exemplary wafer processing system 1 with a housing 3, two airlock units 4, 5, a process unit 7, cassette holding units 9, 10 and a robot 12 having an end effector 13

The housing 3 of the exemplary wafer processing system 1 has a rectangular base with two longitudinal sides and two transverse sides. The housing is formed in such a way that it can provide a clean room atmosphere inside, wherein the wafer processing system 1 itself can also be placed in a clean room. Two cassette airlocks 4, 5 are attached to one of the transverse sides, via which wafer cassettes can be fed into and removed from the housing, as is known in the art. In this embodiment, a distinction is made between wafer cassettes for unprocessed wafers and wafer cassettes for processed wafers. The wafer cassettes for unprocessed wafers are for example of a type intended for the prolonged holding and storage of wafers, while the wafer cassettes for processed wafers are essentially transport cassettes, as they are used for a direct transport of the wafers to a subsequent process. The wafer cassettes for unprocessed wafers are for example fed in/out via airlock 4, while the wafer cassettes for processed wafers are fed in/out via airlock 5. It is also possible for both locks to be used for feeding cassettes in and out. The wafer cassettes can have different dimensions, as will be described in more detail below. Instead of two airlock units 4, 5, however, more or even just one airlock unit could be provided, via which the wafers can be fed in and/or out, as is known in the art. A single wafer cassette type could also be used.

A processing unit 7 is provided within the housing 3, in which wafers can be processed individually or as a batch. Different process units are widely known in the art and are therefore not explained in more detail. In the embodiment shown, the processing unit 7 is arranged adjacent to the transverse side opposite the airlock units 4, 5. As the skilled person will recognize, other arrangements are also possible and are known in the art Adjacent to the process unit and between the process unit 7 and the transverse side with the airlock units 4, 5, two cassette holding units 9, 10 are provided. Wafer cassettes can be accommodated in a known manner and in a defined position on these holding units. The cassette holding units 9, 10 are arranged adjacent to the longitudinal sides of the housing 3, i.e. spaced apart in the transverse direction. In particular, in this embodiment, the cassette inserted via the airlock 4 may for example be received on the cassette holding unit 9, while the cassette inserted via the airlock 5 can be received on the cassette holding unit 10. Accordingly, feeding out of cassettes would take place vice versa, i.e. from cassette holding unit 9 via airlock 4 and from cassette holding unit 10 via airlock 5. Corresponding movement paths are shown in the figure with dashed lines A, B.

The robot 12 with end effector 13 is arranged between the process unit and the airlock units. As shown, the robot 12 has a base 15, three rotating shafts 17, 18, 19, two arms 22, 23 and the aforementioned end effector 13.

The base 15 is fixedly connected to the floor and contains the control electronics for the robot. However, the base 15 could also be mobile and the control electronics arranged externally. The base supports the rotary shaft 17 in such a way that the rotary shaft 17 can be rotated about its axis and can also be moved along its axis. The rotary shaft 17 is therefore formed as a lifting/rotary shaft. At its distal end (remote from the base 15), the rotary shaft 17 carries the first arm 22, which is fixed to the rotary shaft 17 in a rotationally fixed manner and thus rotates with the rotary shaft 17 about the axis of the same. The first arm 22 is an elongated support element that extends substantially perpendicular to the axis of rotation of the rotary shaft 17, as is known in the art.

At its distal end (remote from the rotary shaft 17), the first arm carries a further rotary shaft 18 which extends substantially perpendicular to the first arm and which has an axis of rotation which runs substantially parallel to the axis of rotation of the rotary shaft 17. The first arm has a drive for the rotary shaft 18, or such a drive may also be integrated in the rotary shaft 18. At the distal end of the rotary shaft 18 (remote from the first arm 22), the rotary shaft 18 carries the second arm 23, which is mounted to the same in a rotationally fixed manner so that it rotates together with rotary shaft 18 about the axis thereof. The second arm 23 is an elongated support element that extends substantially perpendicular to the axis of rotation of the rotary shaft 18, as is known in the art.

The second arm carries a further rotary shaft 19 at its distal end (remote from the rotary shaft 18), which extends substantially perpendicular to the second arm 23 and which has an axis of rotation that runs substantially parallel to the axis of rotation of the rotary shaft 18. The second arm 23 has a drive for the rotary shaft 19, or such a drive may also be integrated into the rotary shaft 19. At the distal end of the rotary shaft 19 (remote from the second arm 23), the rotary shaft 19 carries the end effector 13, which is attached to the rotary shaft 19 in such a way that it rotates with the same about the axis of the rotary shaft 19. The rotary shafts 17, 18 and 19 can each be formed as hollow shafts, wherein electrical control lines and/or lines for a working medium for the end effector may pass through the interior of the shafts. Other arrangements for the robot are known in the art, in which, for example, the respective arms have rotary drives in order to rotate about the axes of the shafts, which are formed as fixed shafts. Such arrangements can also be used according to the invention. The drives and movable members form a drive train for the robot, which enables movement and positioning of the end effector.

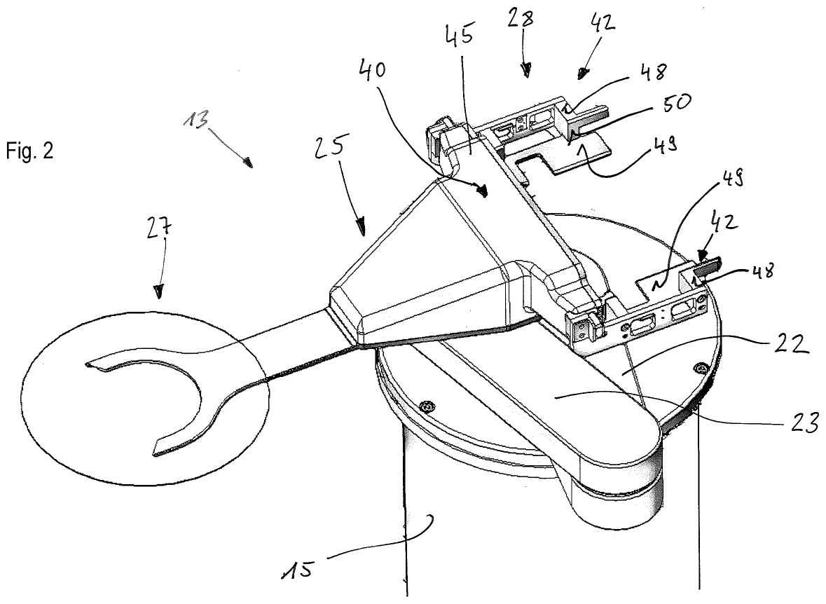

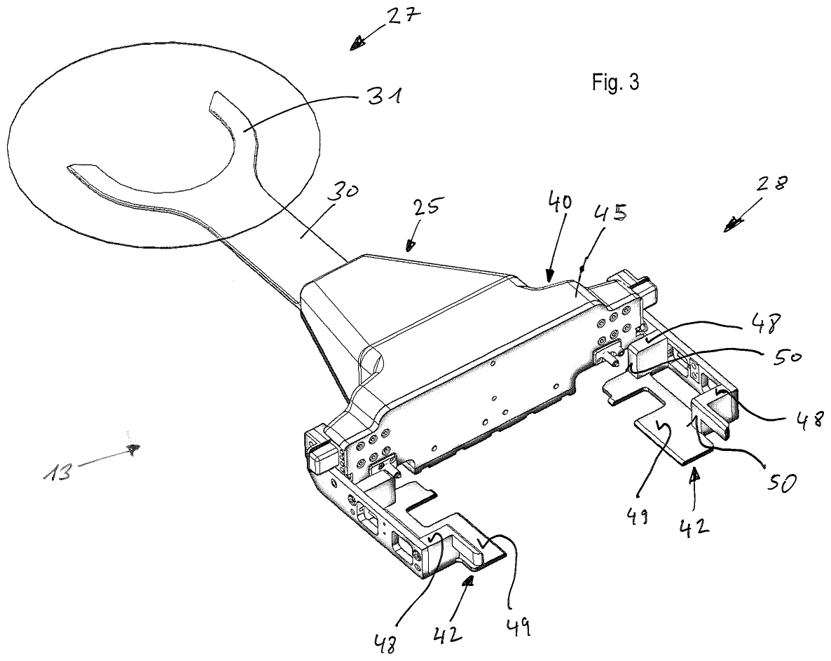

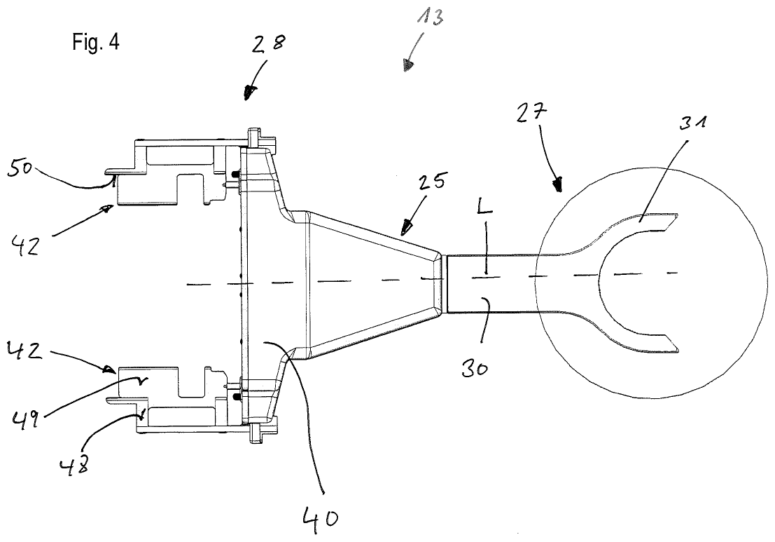

The end effector 13, which is best seen in FIGS. 2 to 4, has a central coupling unit 25, as well as a first gripping unit 27 and a second gripping unit 28, each of which extends from the central coupling unit 25. The central coupling unit 25 is fixedly connected to the rotary shaft 19 and has at least or drive first and second gripping units.

The first gripping unit 27 is formed as a wafer gripper and is used to transport wafers W between the wafer cassette and the process unit and/or between process units if more than one process unit is provided. In the embodiment as shown, the first gripping unit 27 is used, for example, to transport wafers from a wafer cassette on the cassette holder 9 to the process unit 7 (along the indicated path A) and from the process unit 7 to a wafer cassette on the cassette holder 10 (along the indicated path B). The first gripping unit 27 has an elongate carrier 30 and a receiving unit 31 in a known manner.

The carrier 30 is rigidly connected to the coupling unit 25 and carries the receiving unit 31 at its distal end. The carrier extends along a longitudinal axis L running centrally in the transverse direction, which preferably intersects the axis of rotation of the rotary shaft 19 and runs perpendicular to the same. A conduit for a working medium is provided in or on the carrier 30, which is coupled to the coupling unit 25 via a corresponding connection terminal.

The receiving unit 31 is located at the distal end of the carrier 30 and is formed by an in substance C-shaped receptacle that is in substance symmetrical with respect to the longitudinal axis L. The receiving unit 31 is preferably formed in one piece with the carrier 30, but can also be formed as a separate element. At the end points and the apex of the C shape, for example, upward-facing openings can be provided, which are surrounded by a support ridge. The openings are connected to the conduit for the working medium so that it can be applied to a wafer W located above the openings in order to hold it in a defined position. For example, a vacuum may be applied via the openings in order to pull a wafer W against the support ridges and thereby hold and fix it. Compressed air could also be applied in a controlled manner to keep a wafer W suspended and fixed via a Bernoulli effect. Alternatively, the receiving unit could for example also be formed as a so-called edge gripper, which grips or receives a wafer at its edge and thus holds and fixes it securely. Such grippers and alternatives are known in the art and are therefore not described in more detail.

The first gripping unit can also have an orientation or alignment sensor and/or a wafer rotation unit, as is known.

In the embodiment as shown, a single first gripping unit 27 formed as a wafer gripper is provided. However, it would also be possible to provide a plurality of such first gripping units 27 arranged one above the other in order to be able to pick up several wafers W at the same time. These could have a fixed spacing in height from one another if, for example, the spacing between wafers W held in a wafer cassette and the spacing between wafers W held in a process chamber are the same. Alternatively, however, the spacing in height could also be adjustable if, for example, the spacing between wafers W held in a wafer cassette and the spacing between wafers W held in a process chamber are different.

The second gripping unit 28 is formed as a cassette gripper and serves to transport wafer cassettes between airlocks 4, 5 and cassette holders 9, 10. In the embodiment as shown, the second gripping unit 28 serves, for example, to transport a wafer cassette from the airlock 4 to the cassette holder 9 and vice versa (along the indicated path C), and to transport a wafer cassette from the airlock 5 to the cassette holder 10 and vice versa (along the indicated path D). The second gripping unit 28 is attached to the coupling unit 25 at the opposite end with respect to the first gripping unit 27. The longitudinal axis L of the first gripping unit 27 in substance also forms a longitudinal axis of the second gripping unit 28, which runs centrally in the transverse direction. When the end effector 13 is mounted, the axis of rotation of the rotary shaft 19 lies in substance centrally between the first and second gripping units 27, 28.

The second gripping unit 28 comprises an actuating unit 40 and two gripping jaws 42 which are connected to the actuating unit 40. The actuating unit 40 is attached to the coupling unit 25, namely at the opposite end with respect to the first gripping unit 27. The actuating unit 40 is attached to the coupling unit 25 and is in substance formed by a cylinder unit 44 with oppositely movable cylinders. The cylinder unit extends transversely to the longitudinal axis L and is symmetrical in this respect, such that when the cylinders of the cylinder unit move, their ends move substantially symmetrically with respect to a plane formed by the longitudinal axis L and the axis of rotation of the rotary shaft 19. When extending, the free ends of the cylinders thus move uniformly away from the plane and when retracting, they move uniformly towards the plane. The cylinder unit is connected via the coupling unit to a working medium, such as compressed air, vacuum and/or electrical power, which controls the extension and retraction of the cylinders of the cylinder unit in the manner described above. The retraction and extension positions of the cylinder unit can be limited by stops and the positions can be determined using suitable decoders. The cylinders can, for example, be mechanically biased into a retracted position via a spring, so that the working medium must move the cylinders against the bias and the cylinders automatically return to the retracted position, which corresponds to a gripping position, as will be explained in more detail below, in the absence of the working medium.

The actuating unit 40 and the coupling unit 25 may be covered by a common housing 45, as shown in FIGS. 2 to 4.

One of the gripping jaws 42 is attached to the free end of each cylinder of the cylinder unit 44 in such a way that they extend away from the coupling unit 25 substantially parallel to the longitudinal axis L. The gripping jaws are rigidly attached to the cylinders and move with them. When the cylinders are extended, the gripping jaws therefore move apart symmetrically to the above-mentioned plane and when they are retracted, they move symmetrically towards each other into a gripping position, as the skilled person will recognize. The gripping jaws 42 are in substance symmetrical with respect to a plane formed by the longitudinal axis L and the axis of rotation of the rotary shaft 19. The gripping jaws are contoured on the sides facing each other in order to receive and grip a wafer cassette between them. The contour of the gripping jaws 42 is matched to the contour of the wafer cassettes to be gripped. In particular, the contour can be selected in such a way that it can pick up and grip two different wafer cassettes (type/size) with the same stroke of the cylinders.

In the embodiment shown, this is achieved by the gripping jaws 42 each having two support surfaces 48, 49, which are offset in height, and a contact surface 50. The support surfaces 48, 49 extend in substance horizontally and parallel to the direction of movement of the cylinders of the cylinder unit 44. The contact surface 50 extends in substance vertically or perpendicular to the support surfaces. The support surface 48 is arranged above the contact surface 50 and extends backward directly adjacent from the contact surface 50. The support surface 49 is arranged below the contact surface 50 and extends forwards adjacent to the contact surface 50.

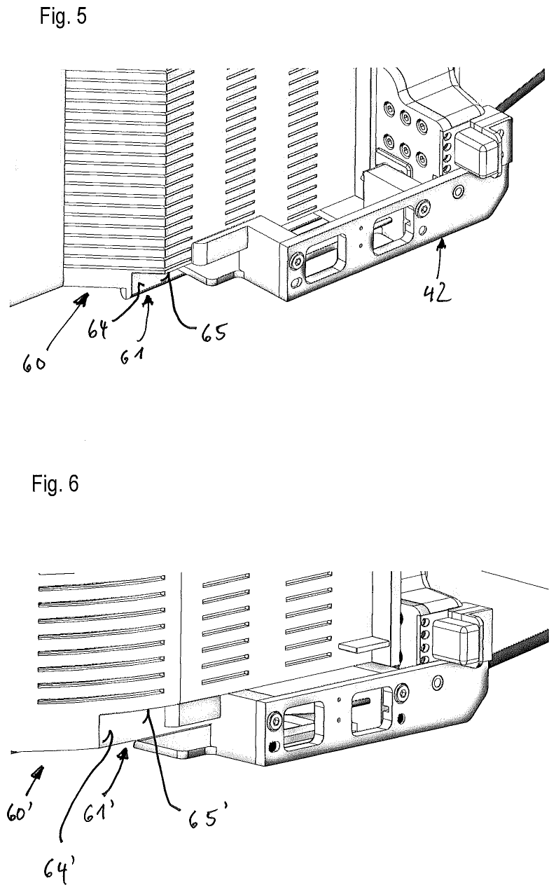

The wafer cassettes to be accommodated have corresponding contours in order to cooperate with the wafer grippers and the respective support and contact surfaces, as is explained in more detail with reference to FIGS. 5 and 6. These Figures each show the engagement of a gripping jaw 42 with a wafer cassette 60, 60′, wherein wafer cassettes of different types or sizes are shown in the figures. At their lower ends, the wafer cassettes 60, 60′ each have a recessed region 61, 61′ extending in the longitudinal direction (perpendicular to a loading/unloading opening) of the wafer cassette in such a way that a laterally facing edge 64, 64′ and a downwardly facing shoulder 65, 65′ are formed in each case. The recessed region 61, 61′ is formed in each case with respect to a side wall of the wafer cassette 60, 60′, which in substance defines the width of the wafer cassette 60, 60′. Supports for the wafers to be accommodated are arranged on the inner sides of the side walls, above the respective recessed regions 61, 61′. The distance between the side walls can thus also limit the size of the wafers to be accommodated.

The distance between the outer surfaces of the side walls of the wafer cassette 60 (FIG. 5) differs from the distance between the outer surfaces of the side walls of the wafer cassette 60′ (FIG. 6). In particular, the distance between the outer surfaces of the side walls of the wafer cassette 60 (FIG. 5) is smaller than the distance between the outer surfaces of the side walls of the wafer cassette 60′ (FIG. 6). However, the distance between the outer surfaces of the laterally facing edges 64′ of the wafer cassette 60′ is substantially equal to the distance between the outer surfaces of the side walls of the wafer cassette 60. Hence, the contact surface 50 of the wafer gripper 42 can engage either with the side walls of the wafer cassette 60 or with the laterally facing edges 64′ using the same stroke, as shown in FIGS. 5 and 6.

In the case of the wafer cassette 60 according to FIG. 5, the lower support surface 49 of the wafer gripper, which extends forwards with respect to the contact surface 50, can move into contact with the downwardly facing shoulder 65 of the recessed region 61 when the wafer gripper is lifted and can thus securely pick up and hold the wafer cassette. In the wafer cassette 60′ as shown in FIG. 6, on the other hand, the upper support surface 48 of the wafer gripper, which extends rearward with respect to the contact surface 50, can move into contact with the downwardly facing shoulder 65′ of the recessed area 61′ when the wafer gripper is lifted and thus securely pick up and hold the wafer cassette. The respective downwardly facing shoulder 65, 65′ is particularly suitable for contact with the respective support surface 48, 49, since this shoulder is generally freely accessible (does not serve as a support surface) and is well defined.

The gripping jaws are therefore contoured in such a way that they can pick up different wafer cassettes (which are contoured accordingly) at the same stroke. Instead of the configuration shown, which is based on the wafer cassettes in the field, other configurations are of course also possible.

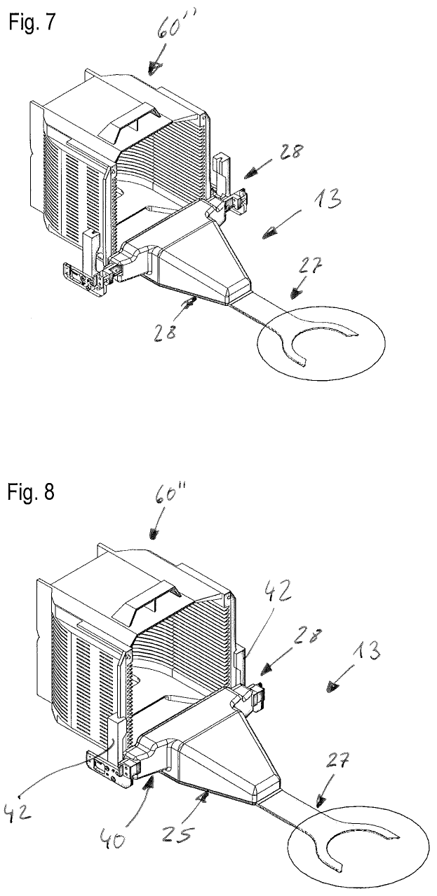

With reference to FIGS. 7 and 8, an alternative embodiment of the end effector 13 is described, using the same reference signs as before to describe the same or similar elements. The end effector 13 again has a central coupling unit 25, as well as a first gripping unit 27 and a second gripping unit 28, each extending from the central coupling unit 25. The central coupling unit 25 and the first gripping unit 27 are essentially identical to the first embodiment and are therefore not described again.

The second gripping unit 28 again has an actuating unit 40 and two gripping jaws 42 which are connected to the actuating unit 40. The actuating unit 40 can have essentially the same structure as in the first embodiment.

The main difference to the first embodiment lies in the gripping jaws 42. While the gripping jaws 42 of the first embodiment have a substantially horizontal orientation with, among other things, horizontal support surfaces, the gripping jaws 42 according to FIGS. 7, 8 have a substantially vertical orientation.

In particular, the gripping jaws 42 of FIGS. 7, 8 are configured for gripping a vertically extending flange of a wafer cassette 60″. Such a flange extends, for example, over the height of the front side (laterally with respect to a loading/unloading opening) of the wafer cassette 60″ and extends outwards with respect to the loading/unloading opening. Such flanges are already provided in some cases for wafer cassettes in the field. The wafer cassette 60″ can be gripped by corresponding engagement with the flanges. For additional support, horizontal supports (not shown) can also be provided on the gripping jaws, which can engage with the underside of the wafer cassette 60″ or with a downward-facing contact surface analogous to the design shown in FIGS. 5 and 6.

The invention has been explained herein above with reference to the embodiments shown in the figures, without being limited to the exact embodiments. In the light of the teaching of the invention, a wide variety of embodiments will present themselves to the skilled person, in particular with regard to the precise embodiments of the first and second gripping units of the end effector.

1. End effector comprising:
a first gripping unit configured to pick up and hold individual wafers;
a second gripping unit configured to pick up and hold a wafer cassette, wherein the first and second gripping units are connected to each other such that they are attachable to a common robot arm and that they are arranged at an angle to each other such that they do not interfere with each other in operation.

2. The end effector according to claim 1, wherein the first and second gripping units are arranged at an angle of approximately 180°to each other.

3. End effector according to claim 1, wherein the first and second gripping units are connected to one another via a coupling unit, wherein the coupling unit can be connected to the common robot arm in such a way that the coupling unit connects at least one connection terminal for a working medium, preferably the same connection terminal, with the first and second gripping units for the actuation of the respective gripping units.

4. End effector according to claim 1, further comprising a rotary unit by means of which the end effector can be attached to the robot arm so as to be rotatable back and forth between at least two positions, the position of the end effector determining the readiness for use of the first or the second gripping unit.

5. End effector according to claim 1, wherein the first gripping unit is formed as a vacuum gripper, Bernoulli gripper or edge gripper.

6. End effector according to claim 1, wherein the second gripping unit has movable jaws, wherein the contour of the jaws is formed in such a way that they can accommodate at least two different wafer cassette sizes or-types with the same amount of travel.

7. End effector according to claim 6, wherein the movable jaws are movable via a cylinder unit, wherein the jaws are mechanically biased into a gripping position.

8. Robot comprising a drive train with at least one robot arm which carries at its distal end an end effector according to claim 1.
